(19) United States
(12) Patent Application Publication
(10) Pub. No.: US 2024/0017577 A1
(43) Pub. Date: Jan. 18, 2024

(54) Wheel Clamp System For Tire Changing Machine

(71) Applicant: Hunter Engineering Company, Bridgeton, MO (US)

(72) Inventors: Michael Olsen, Lake St. Louis, MO (US); Joshua Dierking, Leslie, MO (US)

(21) Appl. No.: 18/214,894

(22) Filed: Jun. 27, 2023

Related U.S. Application Data
(60) Provisional application No. 63/389,364, filed on Jul. 14, 2022.

(51) Int. Cl. B60C 25/05; B60C 25/132

(52) U.S. Cl. CPC B60C 25/0542; B60C 25/132

(57) ABSTRACT

An axial clamping system for securing a wheel assembly onto a tire changer drive spindle. The clamping system consists of a shaft for engaging an axial bore of the drive spindle, configured with a set of ball bearings seated within radial bore arranged in a spiral configuration and which extend into a central bore of the shaft. Axial movement of a plunger within the central bore radially displaces the ball bearings to protrude outboard of the shaft outer surface, engaging a spiral channel within the drive spindle axial bore. Rotation of the clamping system within the drive spindle axial bore while the ball bearings engage the spiral channels, tightens a clamp nut against a wheel assembly seated on a flange of the drive spindle. Counter rotation and retraction of the plunger within the shaft releases the clamping forces, allowing for removal of the wheel assembly from the drive spindle.

### CROSS-REFERENCE TO RELATED APPLICATIONS

The present application is related to, and claim priority from, co-pending U.S. Provisional Patent Application Ser. No. 63/389,634 filed on Jul. 15, 2022, and which is herein incorporated by reference.

### STATEMENT REGARDING FEDERALLY SPONSORED RESEARCH

Not Applicable.

### BACKGROUND OF THE INVENTION

The present invention relates generally to tire changing machines, system for mounting and demounting tires from wheel rims, as well as methods for doing same, and more specifically to a tire changing machine wheel clamp assembly configured to secure a wheel rim or wheel assembly to a spindle shaft during a tire or wheel service procedure.

The process of removing a tire from a wheel rim and replacing it with another tire, referred to herein as tire changing, can be difficult and require the exertion of significant forces to pull, distort, and displace the tire relative to the wheel rim. In response to such difficulties, machines have been developed to facilitate the tire changing process. These tire changing machines commonly include a clamping mechanism to secure the wheel rim, and a drive shaft assembly configured to rotate the secured wheel rim about an axis of a drive spindle. A bead breaker tool exerts forces on the tire adjacent the wheel rim edge to break the tire bead seal loose from the wheel rim. A tire removal tool sometimes referred to as a demount tool or tire hook, is used to pull the released tire bead off the wheel rim as the wheel rim is rotated about the spindle axis, allowing the tire to be separated from the wheel rim for removal. Mounting a tire to a wheel rim involves the reverse process. Manual or machine implemented tools are utilized to press the tire bead around the edge of the wheel rim for installation. While known tire changing machines have obtained some level of success in reducing the time and labor associated with changing a tire, there remains room for improvement, particularly in the ease and speed with which an operator can complete the process of securing a wheel rim and tire assembly onto the drive spindle and subsequent removal there from.

### BRIEF SUMMARY OF THE INVENTION

Briefly stated, the present disclosure provides a tire changing machine with an axial clamping system for rapidly securing a wheel assembly onto a rotatable drive spindle. The clamping system consists of a shaft for engaging an axial bore in the drive spindle. The shaft is configured with a set of ball bearings seated within radial bores adjacent a first axial end of the shaft. The radial bores are arranged in a spiral configuration and extend into a central bore containing a movable plunger. The movable plunger is coupled at an opposite axial end of the shaft to a spring-loaded release tab, such that axial movement of the plunger within the central bore displaces the ball bearings into the radial bores to protrude outboard of the outer surface of the shaft, engaging spiral channels within the peripheral surface of the axial bore of the drive spindle. Handles coupled to the shaft allow an operator to rotate the shaft within the axial bore of the drive spindle while the ball bearing are engaged with the spiral channels, tightening a clamp nut against a wheel assembly seated on the drive spindle. Counter rotation of the handles and retraction of the plunger in the shaft releases the clamping forces, allowing for removal of the wheel assembly from the drive spindle upon completion of a wheel service procedure.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of an exemplary prior art tire changing system;

FIG. 2 is an illustration of a prior art wheel assembly being secured to a tire changing system by a prior art wheel clamp assembly;

FIG. 3 is an exploded perspective view of a clamp assembly of the present disclosure;

FIG. 4 is a sectional view of the clamp assembly of FIG. 3;

FIG. 5 is a second sectional view of the clamp assembly of FIG. 3, sectioned perpendicular to the view of FIG. 4;

FIG. 6 is a sectional view of a tire changing machine drive spindle for receiving the clamp assembly of FIGS. 3-5; and

FIG. 7 is a sectional view illustrating the clamp assembly of FIG. 3 engaged with the tire changing machine drive spindle of FIG. 6.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

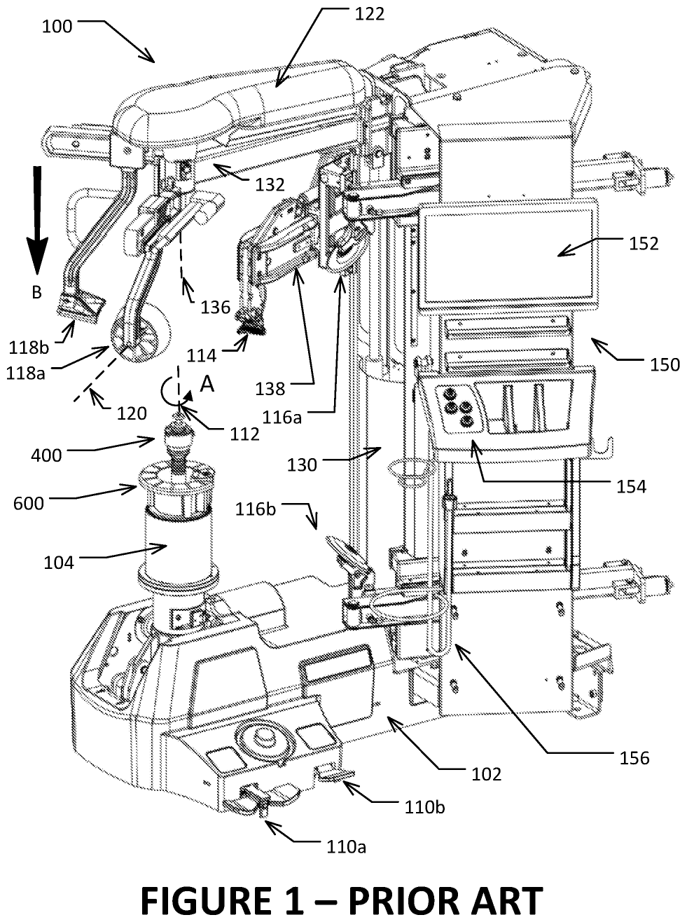

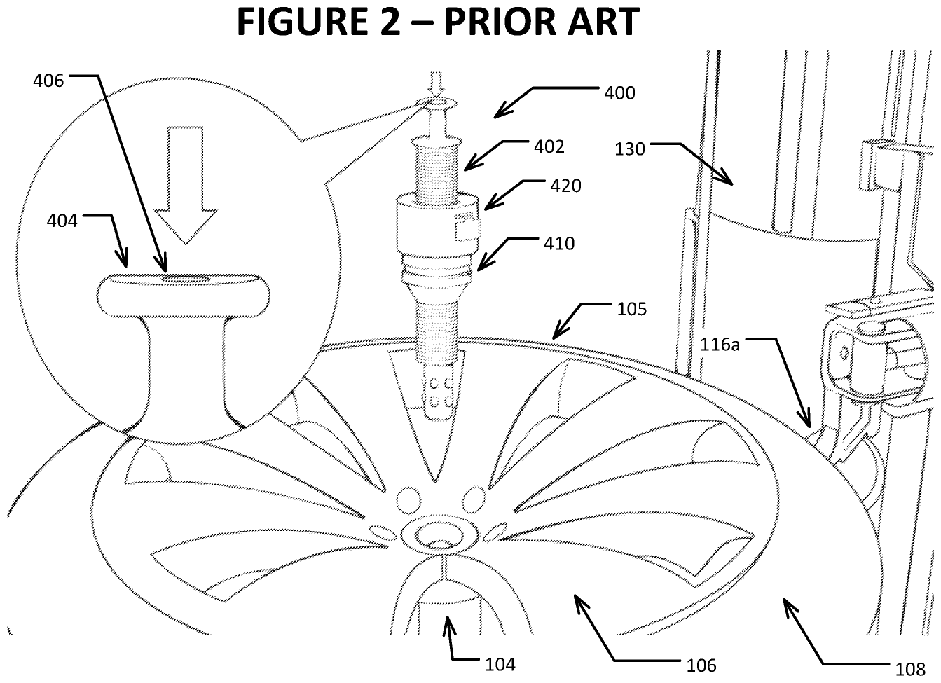

FIG. 1 illustrates a prior art tire changing machine 100 including a frame or base 102 and a rotatable drive shaft assembly 104 attached to the base 102 for receiving and retaining a wheel assembly 105 consisting of a wheel rim 106 having a tire 108. The drive shaft assembly 104 may, as described in U.S. Pat. No. 8,307,874 B1 to Hanneken et al. which is herein incorporated by reference, be configured for movement to different positions to assist with lifting and mounting the wheel rim 106 to the drive shaft assembly 104 and may include a post or shaft positioned centrally on the base 102. As seen in FIG. 2, the wheel rim 106 is secured to the drive shaft assembly 104 with a conventional clamping mechanism passed through a central bore in the wheel rim 106 to engage an axial receiver in the drive shaft assembly 104 after the wheel assembly 105 is loaded and mounted onto the tire changing machine 100.

The conventional clamping mechanism shown in FIG. 2 consists of a clamp nut assembly 400 disposed coaxially about a spindle 402 and secured in an axial position on the spindle 402 by engagement of a ring clamp with annular grooves formed in outer surface of the spindle 104. Engagement and release of the ring clamp is carried out by means of operator-engaged press tabs on the external surface of the clamp nut 420. The clamping mechanism terminates in a short knob 404, having an annular recessed region configured for an operator to easily engage between two fingers, such that the operator's thumb can simultaneously engage an axially extending release button 406 when seating the clamping mechanism within the drive shaft assembly receiver.

After the wheel rim 106 is clamped in position, an operator manipulates an input selector 110a which operates the drive shaft assembly 104 to rotate the wheel assembly 105 about a drive axis 112. In different exemplary embodiments, the drive shaft assembly 104 may be actuated pneumatically, hydraulically, or electrically. Clockwise and counterclockwise rotation about the drive axis 112, indicated by arrow A in FIG. 1, is possible in different embodiments. While the drive axis 112 is illustrated as being generally vertical in the embodiment depicted, the drive axis 112 may be oriented horizontally or otherwise in other embodiments, and a displacement of the drive axis 112 may be selectively adjusted relative to the base 102, such as by linear movement of the drive shaft assembly 104.

As the wheel rim 106 is rotated about the drive axis 112, a tool assembly 114 is brought into physical contact or engagement with the tire 108 in the direction of arrow B, at a location proximate an outer periphery of the rim 106. With the tool assembly 114 properly positioned with respect to the tire 108 and wheel rim 106, the wheel assembly 105 is further rotated about the axis 112 while the engaged tool assembly 114 demounts the tire 108 from the wheel rim 106. The tool assembly 114 may be further utilized to facilitate mounting a replacement tire 108 to a bare wheel rim 106 secured to the drive shaft assembly 104. While a single tool assembly 114 as shown may facilitate both mounting and demounting of tires 108 from the wheel rim 106, it is contemplated that separate mounting and demounting tools may likewise be provided and utilized.

The tool assembly 114 may include features such as a tire hook to separate or displace an inner circumference of the tire 108, including a tire bead surface, (not shown) over the outer lip of the wheel rim 106 to remove the tire 108 during a tire demount operation, or alternatively to engage the inner circumference of the tire 108 including the tire bead during installation or mounting of the tire 108 to the wheel rim 106. The tool assembly 114 is further described in U.S. Pat. No. 8,973,640 B1 to Hanneken, which is herein incorporated by reference.

Bead breaker tools 116a and 116b, are configured to exert pressure on the sidewall surfaces of the tire 108 to either break a seal between the tire bead and the rim 106, or to push or displace the inner circumference of the tire 108 over the outer lip of the wheel rim 106 during installation of the tire 108. As shown in FIG. 1, a first bead breaker tool is located above the tire 108 and second is located below the tire 108. In another embodiment, only a single bead breaker tool 116 is be provided. Exemplary operation of the bead breaker tools 116, 116a, and 116b are more completely described in U.S. Pat. No. 8,613,303 B1 to Hanneken et al., which is herein incorporated by reference.

Machine tools 118a and 118b are provided and sometimes are referred to as pressing tools, pusher tools, or bead pressing devices. As shown in FIG. 1, bead pressing devices 118a, 118b exert pressure on the tire sidewall during tire mounting and demounting procedures. As shown, bead pressing device 118a is a roller mounted for rotation about an axis 120 substantially perpendicular to the machine drive axis 112. Thus, when the roller 118a is placed in contact with a tire sidewall, it rotates about the axis 120 as the tire 108 is rotated about the machine drive axis 112, such that the roller 118a remains in a fixed position relative to the machine drive axis 112. When desired, the roller 118a is operable to rotate in tandem with the tire 108 about the drive axis 112.

The bead pressing device 118b is adapted for contact with the tire 108 and includes a frictional engagement surface to facilitate movement relative to the tire. When engaged with the tire sidewall, the bead pressing device 118b rotates about the drive axis 112 with the tire 108. Optionally the bead pressing device 118b may incorporate a feature for engaging a spoke, a hole, or other feature of the wheel rim 106 to ensure that the bead pressing device 118b (and the tire 108 with which it is engaged) rotate along with the wheel rim 106, and that the bead pressing device 118b does not move relative to the wheel rim 106. Alternatively, the bead pressing device 118b may be coupled with an independent drive mechanism 122 configured to push the bead pressing device 118b and the tire 108 in the direction of rim rotation about the drive axis 112. This establishes a “traction point” in addition to pushing the tire bead into the drop center of the wheel rim 106 when mounting the tire 108.

The bead pressing devices 118a, 118b may be spaced from one another to maintain the tire bead in a drop center of the wheel rim 106 during a tire demounting procedure, or to push the tire bead into the drop center during a tire mounting procedure. While two bead pressing devices 118a and 118b are shown in FIG. 1, additional bead pressing devices 118 may be provided. Two or more bead pressing devices 118 are beneficial for mounting or demounting larger diameter tires and stiffer tires, although it is understood that in some cases a single bead pressing device 118 may be sufficient to mount or demount certain types of tires. Operation of the pressing tools and the independent drive mechanism are more completely described in U.S. Pat. No. 8,387,675 B1 to Vaninger et al., which is herein incorporated by reference.

In different exemplary embodiments, the tool assembly 114, and the machine tools 116, 118 are actuated pneumatically, electrically, or hydraulically, and serve to supply sufficient forces at the correct angles and locations with respect to the tire 108 such that the bead of the tire 108 is forced out of, or into, a bead seat on the wheel rim 106. While exemplary machine tools 116, 118 are illustrated in combination with the tool assembly 114, still other tire changing tools and devices may be provided and used for bead breaking, tire mounting and/or demounting, locating a valve stem, locating a wheel weight, locating a wheel sensor such as a Tire Pressure Monitoring System (TPMS) sensor, or other purposes. Such other tools may be provided in addition to, or in lieu of, the machine tools 116, 118 as depicted.

To assist with locating the tool assembly 114 and the machine tools 116, 118 a sensory capability may further be provided in the machine 100 to detect a position of the tool assembly 114 and the machine tools 116, 118 (or other tools that may be provided) with respect to the tire 108 and/or wheel rim 106. For example, a switch mechanism may be included that changes state when a bead breaker tool moves just beyond the outer edge of the wheel rim 106, ensuring that the tool is positioned to engage the tire 108 at a predetermined location. Machine vision systems can assist in aligning the machine tools with respect to the wheel rim 106 at predetermined locations. Force feedback sensors may be integrated as further monitoring and control features for the machine components, including but not limited to the machine tools. While such sensory capabilities may be beneficial, in some embodiments they may be considered optional and accordingly may not be present or utilized.

The machine 100 as shown in FIG. 1 includes a support tower 130 extending from the base 102 at a location spaced from the drive shaft assembly 104. The support tower 130 extends to a height above any wheel assembly secured to the drive shaft assembly 104. A linkage 132 extends outwardly from the support tower 130, coupling to the bead pressing devices 118a, 118b. The linkage 132 is movable by an actuator on the support tower 130 in a direction parallel to arrow B in FIG. 1, such that the bead pressing devices carried on the linkage 132 are moved either towards or away from the tire 108. As such, the bead pressing devices 118a, 118b may be moved in a direction parallel to the machine drive axis 112.

In addition to movement parallel to the machine drive axis 112, the bead pressing devices 118 are mounted to the linkage 132 such that they are rotatable about an axis 136 that is fixed and coincident with the machine drive axis 112. That is, the bead pressing devices 118 are rotatable about the axis 136 that is coaxial with the machine drive axis 112. Because the axis 136 is coincident with the drive axis 112, when the bead pressing devices 118 are in contact with the tire 108, the bead pressing devices 118 may rotate with the tire 108 as it is rotated about the drive axis 112.

While locating the rotation axis 136 of the bead pressing devices 118 at a fixed and set distance and location from the tower support frame 130 can be beneficial for the reasons stated, it is recognized that in further and/or alternative embodiments, neither the location of the drive axis 112, nor the rotational axis 136 for the bead pressing devices, need necessarily be fixed in such a manner so long as the axes 112 and 136 are adjustable to become coincident when the bead pressing devices 118 are utilized. That is, either or both of the axes 112 and 136 may be movable to different positions, distances and orientations relative to each other, and relative to the tower support frame 130, for reasons not pertinent to the use of the bead pressing devices 118a, 118b, but when the bead pressing devices 118a, 118b are to be engaged to the tire, the axes 112 and 136 are moved to become coincident once again so that the bead pressing devices 118 may rotate with the tire 108 about the drive axis 112.

The bead pressing devices 118a, 118b are further movable in a direction perpendicular to the axis 136 and the drive axis 112. That is, actuators are provided that move the bead pressing devices 118a, 118b radially toward, and away from, the drive axis 112, such that the bead pressing devices 118 may be manually or automatically adjusted to different radial positions measured from the drive axis 112 accommodating tires and rims of different diameters. The bead pressing devices 118 may be manually or automatically positioned in the direction perpendicular to the drive axis 112 as described below.

The bead breaker tools 116a, 116b are coupled to and supported by the tower support frame 130 (or other support structure in an alternative embodiment) via linkages movable in vertical and horizontal directions to position the bead breaker tools 116a, 116b relative to the wheel rim 106 and tire 108 during use.

The tool assembly 114 is likewise coupled to a support 138 and associated linkages on the tower support frame 130 by actuators such that the support 138 is movable relative to the tower support frame 130 in the vertical and horizontal directions. As such, the tool assembly 114 is movable radially toward and away from the drive axis 112, and toward and away from the wheel assembly 105 in a direction parallel to arrow B. The tool assembly 114 operates independent of the tools 116, 118, but may be used in concert while changing the tire 108. The positions of the various components 114, 116, and 118, and operation of the drive shaft assembly 104 and other features of the machine 100 may be coordinated by a programmable control unit and actuator components.

A machine operator may manipulate input selectors 110a, and 110b to direct the control unit to move the tool assembly 114, and the tools 116, 118 to desired positions, to operate the drive shaft assembly 104, or to activate other machine features. In illustrative embodiments, the input selectors 110a, 110b are foot pedals located near the bottom of the machine base 102 for convenient use of the machine operator(s). In other embodiments, input devices 154, including but not limited to levers, buttons, knobs, switches, joysticks, and touch sensitive display 152 may be employed in various locations on or near the machine 100. An operator station 150 including a display 152 and an input device 154 including a keyboard or other input selectors may be optionally provided for the benefit of the operator.

When operating the tire changing machine 100, a preliminary step required before performing a wheel assembly service procedure is to secure the wheel rim 106 to the drive shaft assembly 104. Generally, the wheel rim 106 is secured to the drive shaft assembly 104 by means of a clamping mechanism which retains the wheel rim 106 coaxially against an axial end of the drive assembly.

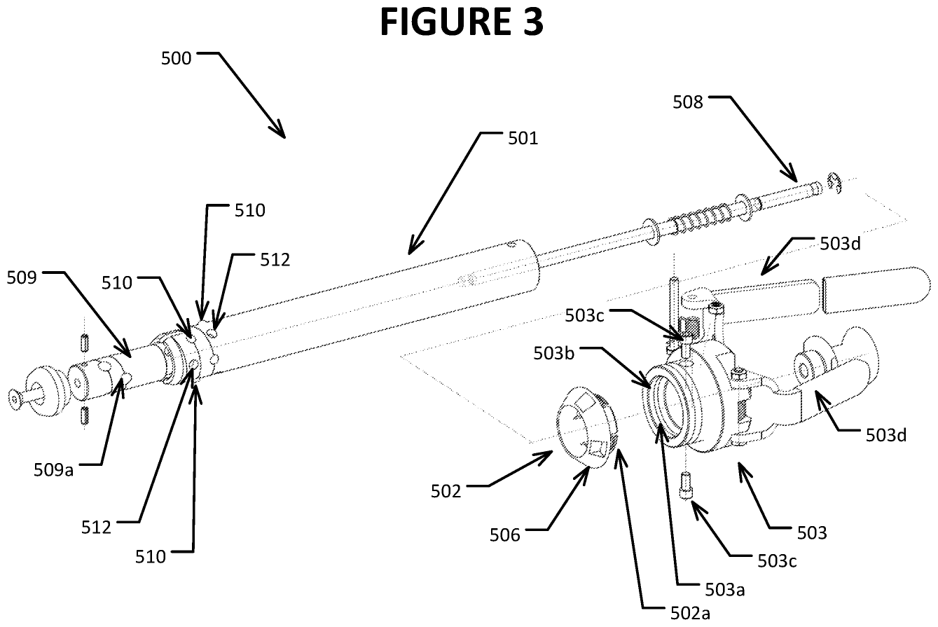

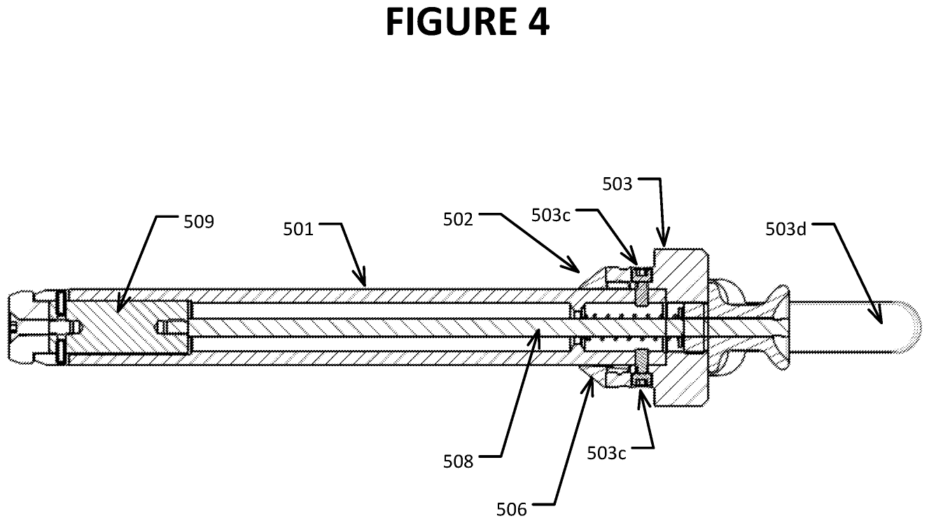

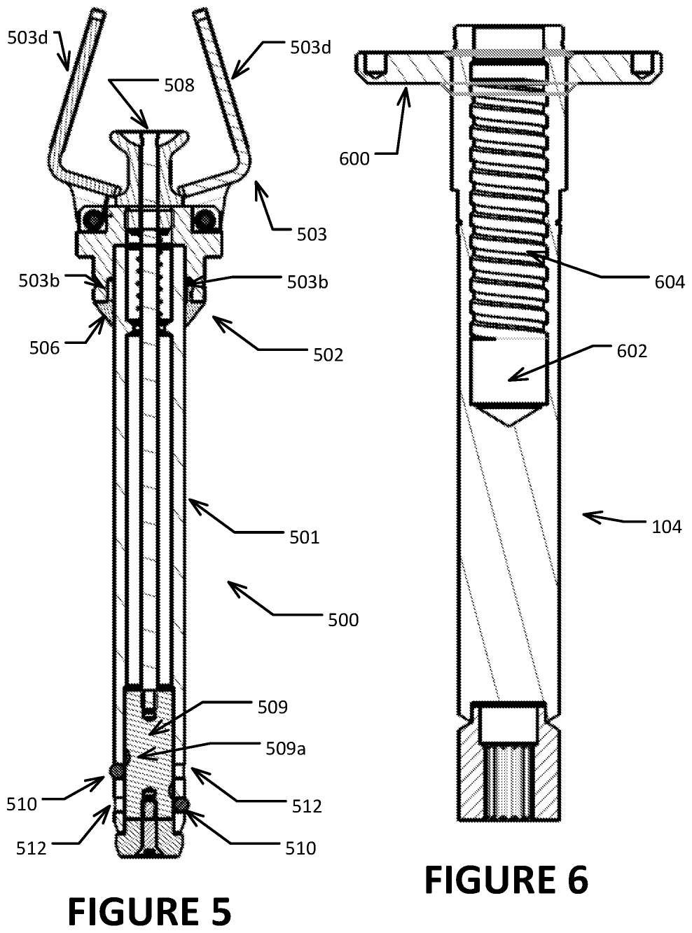

Turning to FIGS. 3-7, a clamping mechanism of the present disclosure is shown generally at 500. The clamping mechanism 500 consists of a hollow spindle assembly 501 for engaging the drive shaft assembly 104, an interchangeable annular wheel cone 502 seated on the spindle assembly 501 for centering a wheel rim 106, and a handle assembly 503 affixed to the spindle assembly 501 axially outboard of the annular wheel cone 502. The handle assembly 503 is secured to the spindle assembly 501 by bolts 503c and includes a pair of folding handles 503d for transferring torque to rotationally clamp or release the spindle assembly 501 to or from the drive shaft assembly 104. The annular wheel cone 502 has an axial bore sized to receive the spindle assembly 501 and includes a conical surface 506 configured to facilitate the centering of a wheel rim 106 center bore about an axis of the clamping mechanism 500. During use, the conical surface 506 seats against a peripheral edge of a wheel's center bore through which the spindle assembly 501 is passed to axially engage with the drive shaft assembly 104, centering the wheel rim 106 about the spindle assembly axis. A set of interchangeable annular wheel cones 502 having differing conical surfaces 506 can be utilized with the spindle assembly 501 to accommodate a variety of different sizes for wheel rim center bores. As shown in FIG. 3, each annular wheel cone 502 is secured coaxial with the handle assembly 503 by means of either snap-fit tabs or a spring-loaded ring 502a engaging an annular recess 503a within the handle assembly 503.

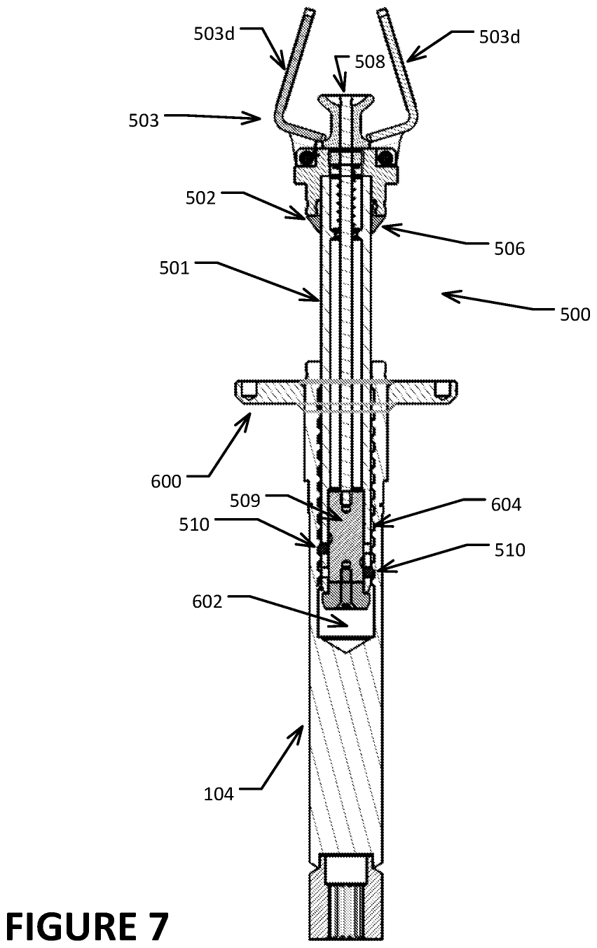

Securing the wheel rim 106 to the drive shaft assembly 104 with the components of the present disclosure requires four steps. Initially the wheel rim 106 is positioned coaxially on a receiving flange 600 at an upper end of the drive shaft assembly 104, best seen in FIG. 6. The spindle assembly 501 is next passed axially through the wheel rim center bore, and into a receiving bore of the drive shaft assembly 104 as shown in FIG. 7 to position the conical surface 506 of the wheel cone 502 in close proximity to, or in contact with an upper edge of the wheel rim center bore. To permit placement of the spindle assembly 501 within the receiving bore, a spring-loaded push rod 508 extending axially from an upper end of the spindle assembly 501 adjacent to the handle assembly 503 is depressed to axially shift an internal cylinder 509 within the spindle assembly 501 adjacent to an axially opposite end. The internal cylinder 509 includes radial recesses 509a in a spiral configuration sized to receive ball bearings 510. Axially shifting the internal cylinder 509 moves the radial recesses 509a into alignment with a set of spiral spaced radial bores 512 passing through the outer wall of the spindle assembly 501, each of which partially contains an associated ball bearing 510, allowing the ball bearings 510 to shift radially into the radial recesses 509a, to be contained within the outer surface of the spindle assembly 501. It will be readily understood that the radial thickness of the spindle assembly outer surface is less than the diameter of the ball bearings 510, thereby ensuring that the ball bearings cannot be fully contained within the radial bores 512 alone. With the ball bearings 510 retracted, the spindle assembly may pass axially through the center bore of the wheel rim 106, and into the receiving bore of the drive shaft assembly 104.

With the spindle assembly 501 in place, the spring-loaded push rod 508 is disengaged, and is biased to return to an extended position, drawing the internal cylinder 509 axially upward. Shifting the internal cylinder 509 moves the radial recesses 509a out of alignment with the radial bores 512, forcing the ball bearings 510 radially outward within the radial bores 512 and into engagement with spiral cut channels 604 within the drive shaft assembly bore 602. Finally, torque is applied to the handle assembly 503 to rotate the entire clamping mechanism 500 about a longitudinal axis of the spindle assembly, drawing the wheel cone 502 into centered clamping engagement with the wheel rim by a threading interaction between the ball bearings 510 and the spiral cut channels 604.

To release the wheel assembly 106, the process is reversed. First, the handle assembly 503 is rotated in reverse to unthread the ball bearings 510 engaged with the spiral cut channels 604 within the drive shaft assembly bore 602, relieving the clamping force exerted on the wheel rim by the wheel cone 502. Next, the spring-loaded push rod 508 is engaged, displacing the internal cylinder 509 within the spindle assembly 501, aligning the radial bores 512 and the radial recesses 509a. With the radial bores 512 and radial recesses 509a aligned, the ball bearings 510 are free to disengage from the spiral cut channels 604, and retract below the surface of the spindle assembly 501. Upon disengagement of the ball bearings 510 from the spiral cut channels 604, the spindle assembly 501 is axially removed from the drive shaft assembly 104 receiving bore 602, and the wheel assembly 106 is released.

As various changes could be made in the above constructions without departing from the scope of the disclosure, it is intended that all matter contained in the above description or shown in the accompanying drawings shall be interpreted as illustrative and not in a limiting sense.

1. A tire changing machine comprising:
a drive assembly configured to receive a wheel rim for rotation about an axis;
a clamping mechanism configured to releasably engage said drive shaft assembly to secure said wheel rim to said drive shaft assembly;
a plurality of tools configured to mount a tire on said wheel rim and to demount said tire from said wheel rim;
at least one input selector configured for operation by a human operator to direct operation of said plurality of tools during a tire service procedure for said wheel assembly secured by said clamping mechanism;
wherein said clamping mechanism includes an annular wheel cone seated on a spindle assembly, said annular wheel cone having a conical surface configured to engage a surface of said wheel rim, and a handle assembly affixed to said spindle assembly, said handle assembly configured to transfer an applied rotational torque to said spindle assembly; and
wherein said spindle assembly is sized for placement within an axial bore of said drive assembly, said spindle assembly including a set of ball bearings seated for radial displacement within a plurality of spiral-spaced radial bores, said set of ball bearings configured to engage, in a first position, at least one spiral channel formed into an inner surface of a central bore of said drive shaft assembly, and to withdraw radially within said spindle assembly in a second position, said ball bearings responsive to axial displacement of an push rod within said spindle assembly to transition between said first and second positions.

2. The tire changing machine of claim 1 wherein said annular wheel cone is releasably secured to said handle assembly, coaxial with said spindle assembly.

3. The tire changing machine of claim 1 wherein said push rod is spring-biased towards a first axial position in which said ball bearings are displaced to said first position.

4. The tire changing machine of claim 3 wherein said push rod terminates at an upper axial end of said spindle assembly in a button, and at a lower axial end at a cylinder member contained coaxially within said spindle assembly, said cylinder member having a plurality of radially oriented recesses arranged in a spiral-spaced configuration to align with said spiral-spaced radial bores when said axial push rod is displaced within said spindle assembly to a second axial position.

5. The tire changing machine of claim 4 wherein an external surface of said cylinder member displaces said ball bearings radially outward towards said first position when said push rod is displaced to said first axial position.

6. The tire changing machine of claim 4 wherein an external surface of said cylinder member receives said ball bearings in said second position within said plurality of radially oriented recesses when said push rod is displaced to said second axial position.

7. The tire changing machine of claim 1 wherein application of torque to said handle assembly in a first rotational direction threads said clamping mechanism into said central bore of said drive shaft assembly while said ball bearings are in said first position.

8. The tire changing machine of claim 7 wherein application of torque to said handle assembly in a second rotational direction unthreads said clamping mechanism from said central bore of said drive shaft assembly while said ball bearings are in said first position.

9. The tire changing machine of claim 1 wherein said clamping mechanism is released from engagement with said central bore of said drive shaft assembly while said ball bearings are in said second position.

10. A tire changing machine wheel rim clamping mechanism, comprising:
a hollow spindle assembly configured for seating axially within a central bore of a tire changing machine drive assembly, coaxially securing a wheel rim against a receiving flange of said drive assembly;
a handle assembly affixed to a first axial end of said hollow spindle assembly;
an annular wheel cone seated concentrically about said hollow spindle assembly, axially adjacent to said handle assembly;
wherein said hollow spindle assembly includes a set of spiral-spaced radial bores adjacent a second axial end, each of said spiral-spaced radial bores holding a ball bearing displaceable between a first position recessed fully within said associated radial bore, and a second position at least partially protruding radially outward from said associated radial bore; and
a push rod located axially within said hollow spindle assembly, said push rod terminating at a first end axially outward of said handle assembly, and at a second end coupled to a cylindrical member having a plurality of spiral-spaced recesses, said push rod and said cylindrical member biased to axially translate between a first axial position in which said spiral-spaced recesses are displaced from said spiral-spaced radial bores, and a second axial position in which said spiral-spaced recesses are aligned with said spiral-spaced radial bores to receive said ball bearings.

11. The tire changing machine wheel rim clamping mechanism of claim 10 wherein said central bore of said drive assembly includes a wheel receiving flange coaxial with said central bore; and
at least one spiral channel recessed into an inner surface of said central bore, said at least one spiral channel sized to receive at least a portion of each of said ball bearings when said push rod and said cylindrical member are in said first axial position with said ball bearings in said second position at least partially protruding radially outward from said associated radial bores in said hollow spindle assembly.

12. The tire changing machine wheel rim clamping mechanism of claim 10 wherein said annular wheel cone has a conical surface configured to seat against an edge of a wheel rim center bore.

13. The tire changing machine wheel rim clamping mechanism of claim 12 wherein said annular wheel cone is interchangeable with at least one additional annular wheel cone having a different conical surface configuration.

14. The tire changing machine wheel rim clamping mechanism of claim 10 wherein said annular wheel cone is releasably coupled to said handle assembly.

15. The tire changing machine wheel rim clamping mechanism of claim 10 wherein said push rod and said cylindrical member are spring-biased towards said first axial position within said hollow spindle assembly.

16. A method for securing a wheel rim to a drive assembly of a tire changing machine using the wheel rim clamping mechanism of claim 10, comprising:
positioning a wheel rim on a wheel receiving flange of said drive assembly;
axially depressing said first end of said axial push rod on said hollow spindle assembly into said second axial position, axially aligning said spiral-spaced recesses on said cylindrical member with said spiral-spaced radial bores;
passing said hollow spindle assembly through said wheel rim center bore and into said drive assembly central bore until said annular wheel cone conical surface is in at least close proximity to an edge of said wheel rim center bore;
releasing said axial push rod first end to return said axial push rod to said first axial position, displacing said spiral-spaced recesses on said cylindrical member from axial alignment with said spiral-spaced radial bores, driving said associated ball bearings radially outward from said spiral-spaced radial bores and into engagement with a spiral-cut channel within said drive assembly central bore; and
applying a rotational torque in a first direction to said handle assembly, said rotational torque threading said hollow spindle assembly into said drive assembly central bore by engagement of said ball bearings with said spiral-cut channel, clamping said wheel rim coaxially between said annular wheel cone conical surface and said wheel receiving flange.

17. The method of claim 16 wherein releasing said wheel rim from between said annular wheel cone conical surface and said wheel receiving flange includes
applying a rotational torque in a second direction to said handle assembly, said rotational torque in said second direction unthreading said hollow spindle assembly from said drive assembly central bore by engagement of said ball bearings with said spiral-cut channel, unclamping said annular wheel cone conical surface from said wheel rim;
axially displacing said first end of said axial push rod on said spindle assembly into said second axial position to axially align said spiral spaced recesses on said cylindrical member with said spiral-spaced radial bores, withdrawing said associated ball bearings from engagement with said spiral-cut channel; and
withdrawing said hollow spindle assembly from said wheel rim center bore and said drive assembly central bore, releasing said wheel rim.

18. The method of claim 16 wherein axially displacing said first end of said axial push rod on said spindle assembly into said second axial position, axially aligns said spiral-spaced recesses on said cylindrical member with said spiral-spaced radial bores, shifting said ball bearings radially inward from said spiral-spaced radial bores.
